(19) United States
(12) Patent Application Publication
(10) Pub. No.: US 2015/0204376 A1
(43) Pub. Date: Jul. 23, 2015

(54) DEVICE FOR HANGING ITEMS ON A VERTICAL SURFACE AND METHOD FOR MAKING AND USING SAME

(71) Applicant: CCL Label, Inc., Framingham, MA (US)

(72) Inventors: Peter Privitera, San Francisco, CA (US); Alexander Robert Brown, San Jose, CA (US); Tark Abed, Palo Alto, CA (US); Arthur Charles Kwun, Newark, CA (US); Eric Cushing, Riverside, CA (US); Sujith Chacko, Arcadia, CA (US)

(73) Assignee: CCL Label, Inc., Framingham, MA (US)

(21) Appl. No.: 14/160,854

(22) Filed: Jan. 22, 2014

(51) Int. Cl. F16B 47/00

(52) U.S. Cl. CPC F16B 47/003

(57) ABSTRACT

The present invention relates to a device designed to permit various items to be hung on a vertical surface (e.g., the hanging of a picture or other piece of framed art or memorabilia on a wall), to a method of making such a device and to a method of using same. In one embodiment, the present invention relates to a two piece device where a first body, or rail, piece and a second body, or rail, piece each engage one of either the object, regardless of whether or not such object is framed or unframed, to be hung or the wall on which the object to be hung is to be placed, wherein the first piece and the second piece are formed so as to engage one another thereby resulting in the hanging of the object on a desired place on a wall. In another embodiment, the present invention relates to a two piece wall hanging device that permits the level hanging of an object on a wall regardless of whether or not each of the two pieces of the device are attached in a level manner to each of the wall and the object to be hung.

### FIELD OF THE INVENTION

The present invention relates to a device designed to permit various items to be hung on a vertical surface (e.g., the hanging of a picture or other piece of framed art or memorabilia on a wall), to a method of making such a device and to a method of using same. In one embodiment, the present invention relates to a two piece device where a first body, or rail, piece and a second body, or rail, piece each engage one of either the object, regardless of whether or not such object is framed or unframed, to be hung or the wall on which the object to be hung is to be placed, wherein the first piece and the second piece are formed so as to engage one another thereby resulting in the hanging of the object on a desired place on a wall or surface. In another embodiment, the present invention relates to a two piece wall hanging device that permits the level hanging of an object on a wall regardless of whether or not each of the two pieces of the device are attached in a level manner to each of the wall and the object to be hung.

### BACKGROUND OF THE INVENTION

As is well known to those who have hung objects on walls, various wall hanging devices are available. Such devices include, for example, picture hooks, adhesive hooks, and eye screws. As would be apparent to those who have utilized such devices, all of these devices suffer from one or more drawbacks. For example, picture hooks need to be selected in the appropriate size so as to hold the correct amount of weight and require at least one nail to be inserted into, or through, the wall surface on which the object in question is to be hung. Turning to adhesive hooks, these devices can leave behind undesirable adhesive residue on the wall surface on which they are placed and/or damage the wall covering and/or painted surface of the wall on which the object is to be hung. Furthermore, eye screws need to be placed into supporting wall studs and/or secured in the wall material using a molly or some other anchoring device. Additionally, some of the above mounting and/or hanging devices require an installer to utilize tools to achieve the desired hanging of an object on the wall and/or to achieve a level hanging of the object on the wall.

As such, it is often difficult, if not impossible, to accurately and/or easily use the various wall mounting and/or hanging devices of the prior art. Accordingly, there is a need in the art for an improved wall mounting and/or hanging device that overcomes one or more of the various shortcomings detailed above.

### SUMMARY OF THE INVENTION

The present invention relates to a device designed to permit various items to be hung on a vertical surface (e.g., the hanging of a picture or other piece of framed art or memorabilia on a wall), to a method of making such a device and to a method of using same. In one embodiment, the present invention relates to a two piece device where a first body, or rail, piece and a second body, or rail, piece each engage one of either the object, regardless of whether or not such object is framed or unframed, to be hung or the wall on which the object to be hung is to be placed, wherein the first piece and the second piece are formed so as to engage one another thereby resulting in the hanging of the object on a desired place on a wall. In another embodiment, the present invention relates to a two piece wall hanging device that permits the level hanging of an object on a wall regardless of whether or not each of the two pieces of the device are attached in a level manner to each of the wall and the object to be hung.

In one embodiment, the present invention relates to a wall hanging system comprising: a wall portion, the wall portion comprising a body having a first side and a second side and an adhesive strip, wherein the adhesive strip is located on the first side of the body of the wall portion and is formed so as to cover only a lower portion of the first side of the body of the wall portion; and an object portion, the object portion comprising a body having a first side and a second side and an adhesive strip, wherein the adhesive strip is located on the first side of the body of the object portion and is formed so as to cover only an upper portion of the first side of the body of the object portion, wherein the adhesive strip of the wall portion operatively engages a wall surface and the adhesive strip of the object portion operatively engages an object to be hung, or mounted, on the wall, and wherein the lack of an adhesive strip on an upper portion of the first side of the wall portion creates a space between the body of the wall portion and the wall that the lower portion of the body of the object portion is able to securely engage.

In another embodiment, the present invention relates to a wall hanging system comprising: a wall portion, the wall portion comprising a body having a first side and a second side, an adhesive strip and an adhesive guard, wherein the adhesive strip is located on the first side of the body of the wall portion and is formed so as to cover only a lower portion of the first side of the body of the wall portion and the adhesive guard is formed from a raised horizontally oriented ridge located above a top edge of the adhesive strip; and an object portion, the object portion comprising a body having a first side and a second side, an adhesive strip and an adhesive guard, wherein the adhesive strip is located on the first side of the body of the object portion and is formed so as to cover only an upper portion of the first side of the body of the object portion and the adhesive guard is formed from a raised horizontally oriented ridge located below a bottom edge of the adhesive strip, wherein the adhesive strip of the wall portion operatively engages a wall surface and the adhesive strip of the object portion operatively engages an object to be hung, or mounted, on the wall, and wherein the lack of an adhesive strip on an upper portion of the first side of the wall portion creates a space between the body of the wall portion and the wall that the lower portion of the body of the object portion is able to securely engage.

In still another embodiment, the present invention relates to a wall hanging system comprising: a folded wall portion, the folded wall portion comprising a body having a first portion and a second portion that are joined together along an edge, an adhesive strip and a slot, wherein the adhesive strip is located on a first side of the second portion of the body of the wall portion and the slot is formed in a portion of the edge that joins the first portion and the second portion of the body of the wall portion; and an object portion, the object portion comprising a body having a first side and a second side, an adhesive strip, and a curved bottom edge, wherein the adhesive strip is located on the second side of the body of the object portion and is formed so as to cover only an upper portion of the second side of the body of the object portion, wherein the adhesive strip of the wall portion operatively engages a wall surface and the adhesive strip of the object portion operatively engages an object to be hung, or mounted, on the wall, and wherein at least a portion of the curved edge of the body of the object portion is formed so as to pass through the slot formed in the body of the wall portion.

In still another embodiment, the present invention relates to a wall hanging system comprising: a folded object portion, the folded object portion comprising a body having a first portion and a second portion that are joined together along an edge, an adhesive strip and a slot, wherein the adhesive strip is located on a first side of the second portion of the body of the object portion and the slot is formed in a portion of the edge that joins the first portion and the second portion of the body of the object portion; and a wall portion, the wall portion comprising a body having a first side and a second side, an adhesive strip, and a curved top edge, wherein the adhesive strip is located on the second side of the body of the wall portion and is formed so as to cover only a bottom portion of the second side of the body of the wall portion, wherein the adhesive strip of the wall portion operatively engages a wall surface so that the curved top edge of the wall portion is facing up and the adhesive strip of the folded object portion operatively engages an object to be hung, or mounted, on the wall, and wherein at least a portion of the curved edge of the body of the wall portion is formed so as to pass through the slot formed in the body of the object portion.

### BRIEF DESCRIPTION OF THE DRAWINGS

FIGS. 1A and 1B are illustrations of one embodiment of a wall portion of a picture hanging and/or mounting device according to the present invention;

FIGS. 2A through 2C are illustrations of one embodiment of an object portion of a picture/object hanging and/or mounting device according to the present invention;

FIGS. 2D is an illustration of a set comprising a wall portion and an object portion of the picture/object hanging and/or mounting device of FIGS. 1 and/or 2 that together form one embodiment of the picture/object hanging and/or mounting device of the present invention;

FIGS. 3A through 3C are illustrations of another embodiment of a wall hanging and/or mounting device in accordance with the present invention.

### DETAILED DESCRIPTION OF THE INVENTION

The present invention relates to a device designed to permit various items to be hung on a vertical surface (e.g., the hanging of a picture or other piece of framed art or memorabilia on a wall), to a method of making such a device and to a method of using same. In one embodiment, the present invention relates to a two piece device where a first body, or rail, piece and a second body, or rail, piece each engage one of either the object, regardless of whether or not such object is framed or unframed, to be hung or the wall on which the object to be hung is to be placed, wherein the first piece and the second piece are formed so as to engage one another thereby resulting in the hanging of the object on a desired place on a wall. In another embodiment, the present invention relates to a two piece wall hanging device that permits the level hanging of an object on a wall regardless of whether or not each of the two pieces of the device are attached in a level manner to each of the wall and the object to be hung.

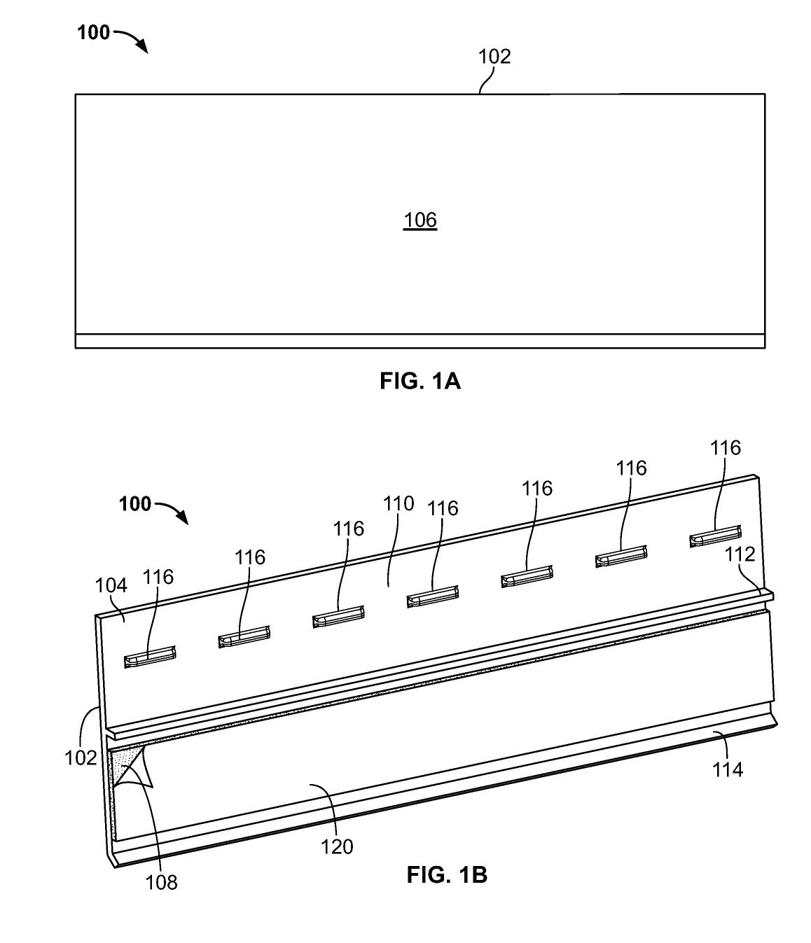

Turning to FIGS. 1A and 1B, these Figures illustrate a wall portion 100 of an overall wall hanging and/or mounting system according to one embodiment of the present invention. As can be seen from FIGS. 1A and 1B, wall portion 100 of the present wall hanging system or device of the present invention is formed from a substantially rectangular piece of material 102. As would be apparent to those of skill in the art, wall portion 100 of this embodiment of the present invention is not limited to just a rectangular shape. Instead, wall portion 100 can be formed in any suitable geometric shape including, but not limited to, square, rectangular, rhomboid, parallelogram, etc.

As can be seen in FIGS. 1A and 1B, wall portion 100 has a first surface 104, a second surface 106, and an adhesive portion 108. As can be seen from FIG. 1B, adhesive portion 108 is located on a lower portion of first surface 104 of wall portion 100. As would be apparent to those of skill in the art, the amount of surface area on first surface 104 that is covered with adhesive portion 108 is not critical so long as wall portion 100 is able to securely engage and be mounted on a wall surface. In another embodiment, adhesive portion 108 can further include, if so desired, a release strip, or liner, 120 so as to protect the adhesive portion 108 when the adhesive is not in use. The nature of such a release strip, or liner, 120 is well known to those of skill in the art. As such, any suitable release strip, or liner, material known in the labeling, tape, or mounting device arts can be utilized.

As would be understood by those of skill in the art, depending upon the weight of the object to be hung and/or mounted on a wall the amount of adhesive could be increased. Alternatively, a different type of adhesive material can be utilized where the holding strength of adhesive material 108 is increased in response to the amount of weight that is desired to be secured by the overall wall hanging and/or mounting system of the present invention. In one embodiment, adhesive portion 108 is formed from any suitable adhesive material and can be selected from a double-sided adhesive tape that has a permanent adhesive material on one side (the side that is secured to the wall portion 100 of the wall hanging system of the present invention) and a removable adhesive material on the other side (the side that is used to secure the wall portion 100 of the present invention to a wall surface). The adhesive tape can further include a foam core portion, which may be positioned between the permanent adhesive and removable adhesive. Such double-sided tapes are known to those of skill in the art and are available from Essentra Specialty Tapes of Forest Park, Ill., USA.

In another embodiment, adhesive portion 108 is formed from a double-sided tape material having an adhesive material that is selected so as to have a removable and reusable adhesive on both sides of the tape. Such double-sided tapes with removable adhesives on both sides are known to those of skill in the art, and as such a detailed discussion herein is omitted for the sake of brevity. In still another embodiment, at least the portion of adhesive portion 108 that contacts the wall surface is formed from an adhesive material that is selected so as to be removable, reusable and residue-free. Again, such adhesive materials are known to those of skill in the art and as such a detailed discussion herein is omitted for the sake of brevity. As used herein “residue-free” means that no undesirable stains or other residues are left on the wall surface onto which adhesive portion 108 is placed.

The thickness of adhesive portion 108 is not critical so long as adhesive portion 108 is of sufficient thickness to create a gap between the wall and an adhesive-free top portion 110 of first surface 104 of wall portion 100—the foam core of the adhesive portion 108 can provide the appropriate thickness of this operative gap. In one embodiment, adhesive portion 108 is formed so as to have a thickness of about 0.02 inches to about 0.25 inches, or from about 0.05 inches to about 0.15 inches, or from about 0.06 inches to about 0.1 inches, or even about 0.0625 inches. Here, as well as elsewhere in the specification and claims, individual numerical values can be combined to form additional and/or non-disclosed ranges.

Given the above, wall portion 100 of the overall wall hanging and/or mounting system of the present invention is mounted and/or placed in a generally level position on any given wall at a desired position using adhesive portion 108 on the back of wall portion 100 to secure same to the wall. Such a mounting of wall portion 100 yields a gap between the portion of first surface 104 of wall portion 100 that is not covered with adhesive portion 108 and the wall. As will be explained in more detail below, this gap permits the other portion, object portion of the overall wall hanging and/or mounting system of the present invention to engage wall portion 100 thereby permitting these two pieces to form an overall hanging and/or mounting system of the present invention. This engagement also accomplishes the desired hanging and/or mounting of an object on a wall.

In another embodiment, wall portion 100 of the overall wall hanging and/or mounting system of the present invention can optionally include one or more of an adhesive guard 112 in the form of a raised horizontal ridge; a bottom lip 114 formed from a raised horizontal, or slanted, ridge; and/or one or more raised locking features 116. In one embodiment, raised features 116 can be formed to be any suitable geometric shape including, but not limited to, rectangular shapes, square shapes, triangular shapes, etc. (see FIG. 1B). When one or more raised features 116 are present on wall portion 100 of the wall hanging and/or mounting system of the present invention, such one or more raised features 116 can serve to provide a sensory confirmation to a user that an object portion is securely engaged with a wall portion 100 of the wall hanging and/or mounting system of the present invention thereby resulting in a securely hung item (e.g., a picture).

In another embodiment, wall portion 100 and a corresponding object portion of the wall hanging and/or mounting system of the present invention are identical in design and are represented by the various embodiments of wall portion 100 illustrated in FIGS. 1A and 1B. In such embodiments, for example, object portion can optionally include one or more of the adhesive guard 112 in the form of a raised horizontal ridge; a bottom lip 114 formed from a raised horizontal, or slanted, ridge; and/or one or more raised locking features 116. As with the above-disclosed embodiment, raised features 116 can be formed to be any suitable geometric shape including, but not limited to, rectangular shapes, square shapes, triangular shapes, etc. (see FIG. 1B). When one or more raised features 116 are present on object portion and/or wall portion 100 of the wall hanging and/or mounting system of the present invention, such one or more raised features 116 can serve to provide a sensory confirmation to a user that an object portion is securely engaged with a wall portion 100 and/or object portion of the wall hanging and/or mounting system of the present invention thereby resulting in a securely hung item (e.g., a picture).

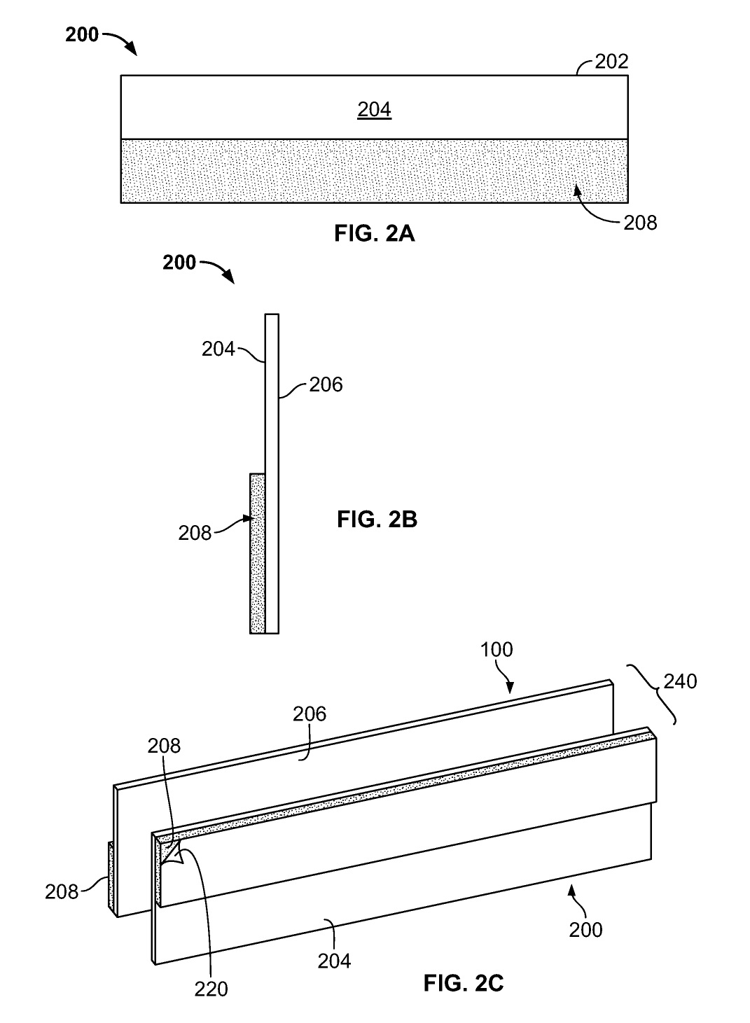

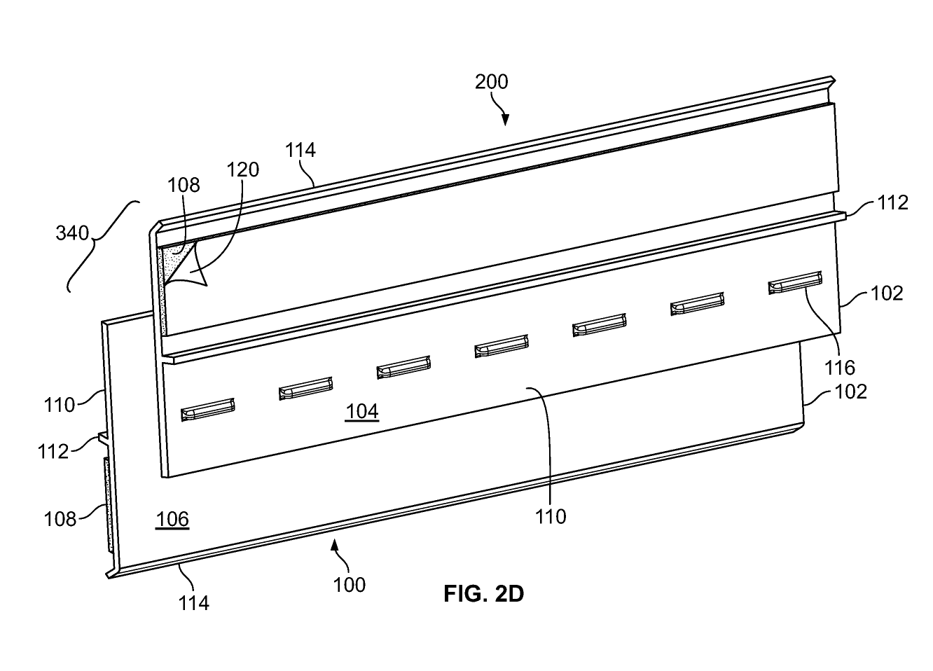

Turning to FIGS. 2A through 2C, these Figures represent another possible embodiment for an object portion 200 of a wall hanging and/or mounting system in accordance with the present invention. In this embodiment, object portion 200 of the present wall hanging system or device of the present invention is formed from a substantially rectangular piece of material 202. As would be apparent to those of skill in the art, object portion 200 of this embodiment of the present invention is not limited to just a rectangular shape. Instead, object portion 200 can be formed in any suitable geometric shape including, but not limited to, square, rectangular, rhomboid, parallelogram, etc.

As can be seen in FIGS. 2A through 2C, object portion 200 has a first surface 204, a second surface 206, and an adhesive portion 208. As can be seen from FIG. 2A, adhesive portion 208 is located on a lower portion of the first surface 204 of object portion 200. As would be apparent to those of skill in the art, the amount of surface area on first surface 204 that is covered with adhesive portion 208 is not critical so long as object portion 200 is able to securely engage and be mounted on the object to be hung. In another embodiment, adhesive portion 208 can further include, if so desired, a release strip, or liner, 220 so as to protect the adhesive portion 208 when the adhesive is not in use. The nature of such a release strip, or liner, 220 is well known to those of skill in the art. As such, any suitable release strip, or liner, material known in the labeling, tape, or mounting device arts can be utilized.

FIG. 2C illustrates an embodiment where two object portions 200 are used together to hang an object on a wall or some other desired surface. In this embodiment, one piece of the set 240 is referred to as object portion 200 and the other is referred to as wall portion 100 for purposes of differentiating between the two identical portions of the wall hanging system of the present invention. When in use, the bottom portion of object portion 200 of set 240 engages the space created by the top portion wall portion 100 when it is mounted on the wall (or other surface) via adhesive strip 208 of the wall portion 100 of FIG. 2C.

As would be understood by those of skill in the art, depending upon the weight of the object to be hung and/or mounted on a wall the amount of adhesive could be increased. Alternatively, a different type of adhesive material could be utilized where the holding strength of adhesive material 208 is increased in response to the amount of weight that is desired to be secured by the overall wall hanging and/or mounting system of the present invention. In one embodiment, adhesive portion 208 is formed from any suitable adhesive material and can be selected from a double-sided adhesive tape that has a permanent adhesive material on one side (the side that is secured to the object portion 200 of the wall hanging system of the present invention), a removable adhesive material on the other side (the side that is used to secure the object portion 200 of the present invention to the object to be hung on a wall), and a foam core there between. Again, such double-sided tapes are known to those of skill in the art and are available from Essentra Specialty Tapes of Forest Park, Ill., USA.

In another embodiment, adhesive portion 208 is formed from a double-sided tape material having an adhesive material that is selected so as to have a removable and reusable adhesive on both sides of the tape with a foam core there between. Such double-sided tapes with removable adhesives on both sides are known to those of skill in the art, and as such a detailed discussion herein is omitted for the sake of brevity. In still another embodiment, at least the portion of adhesive portion 208 that contacts the wall surface is formed from an adhesive material that is selected so as to be removable, reusable and residue-free. Again, such adhesive materials are known to those of skill in the art and as such a detailed discussion herein is omitted for the sake of brevity. As used herein “residue-free” means that no undesirable stains or other residues are left on the wall surface onto which adhesive portion 208 is placed.

The thickness of adhesive portion 208 is not critical so long as adhesive portion 208 is of sufficient thickness to create a gap between the wall and the adhesive-free top portion of the first surface 204 of the wall portion—the foam core of the adhesive portion 208 can provide the appropriate thickness of this operative gap. In one embodiment, adhesive portion 208 is formed so as to have a thickness of about 0.02 inches to about 0.25 inches, or from about 0.05 inches to about 0.15 inches, or from about 0.06 inches to about 0.1 inches, or even about 0.0625 inches. Here, as well as elsewhere in the specification and claims, individual numerical values can be combined to form additional and/or non-disclosed ranges.

In another embodiment, wall portion 100 and a corresponding object portion 200 of a wall hanging and/or mounting system according to the present invention are identical in design and are represented by the embodiment of object portion 200 illustrated in FIGS. 2A through 2C. In this instance, both wall portion 100 and object portion 200 of the wall hanging and/or mounting system of the present invention would be identical to that of objection portion 200 that is discussed with regard to FIGS. 2A through 2C. In this embodiment, one portion (wall portion 100) would be secured to the wall via adhesive portion 208 while the other portion (object portion 200) would be secured to the object to be hung and/or mounted via its own adhesive portion 208.

Regarding the material from which any of wall portion 100 and/or object portion 200 can be formed, the present invention is not limited to any one material choice. Instead, each portion 100 and/or 200 of the wall hanging and/or mounting system of the present invention can be independently formed from metal, plastic, wood, etc. When one or more of the pieces of the wall hanging and/or mounting system of the present invention are formed from a metal, or alloy, material suitable metal materials include, but are not limited to, aluminum, steel, stainless steel, brass, bronze, copper, tin, titanium, etc. When one or more of the pieces of the wall hanging and/or mounting system of the present invention are formed from a plastic, or polymer, material suitable polymer materials include, but are not limited to, polypropylene, polystyrene, polyethylene, acrylonitrile butadiene styrene, etc. As would be apparent to those of skill in the art, each piece of the wall hanging and/or mounting system of the present invention can be independently formed from any of the materials listed above. One potential key consideration to determine the appropriate material is the flexural modulus of the material, i.e., the flexibility of the material at a predetermined thickness. Using a test, such as the ASTM D790 one range of flexural modulus for one embodiment may be between approximately 1.1 GPa to 3.0 GPa. The present teachings, however, are not limited to this configuration.

Turning to FIG. 2D, this Figure illustrates the use of a wall hanging and/or mounting system in accordance with the present invention where both wall portion 100 and object portion 200 thereof form a set 340 where both pieces of set 340 are formed in accordance with the embodiments detailed in FIGS. 1A and 1B. As can be seen from FIG. 2D, when mounting a wall portion 100 the wall portion 100 might be oriented in such a manner that the adhesive portion, or strip, 108 is be located at the bottom. On the other hand, when mounting an object portion 200 the object portion 200 might be oriented in such a manner that the adhesive portion, or strip, 108 might be located at the top. In this instance, both wall portion 100 and object portion 200 of the wall hanging and/or mounting system of the present invention would be identical to that of objection portion 200 that is discussed with regard to FIGS. 1A and 1B. In this embodiment, one half of the set 340 is referred to as object portion 200 and the other is referred to as wall portion 100 for purposes of differentiating between the two identical portions of the wall hanging system of the present invention. When in use, the bottom portion of object portion 200 of set 340 engages the space created by the top portion wall portion 100 when it is mounted on the wall (or other surface) via adhesive strip 208 of the wall portion 100 of FIG. 2D.

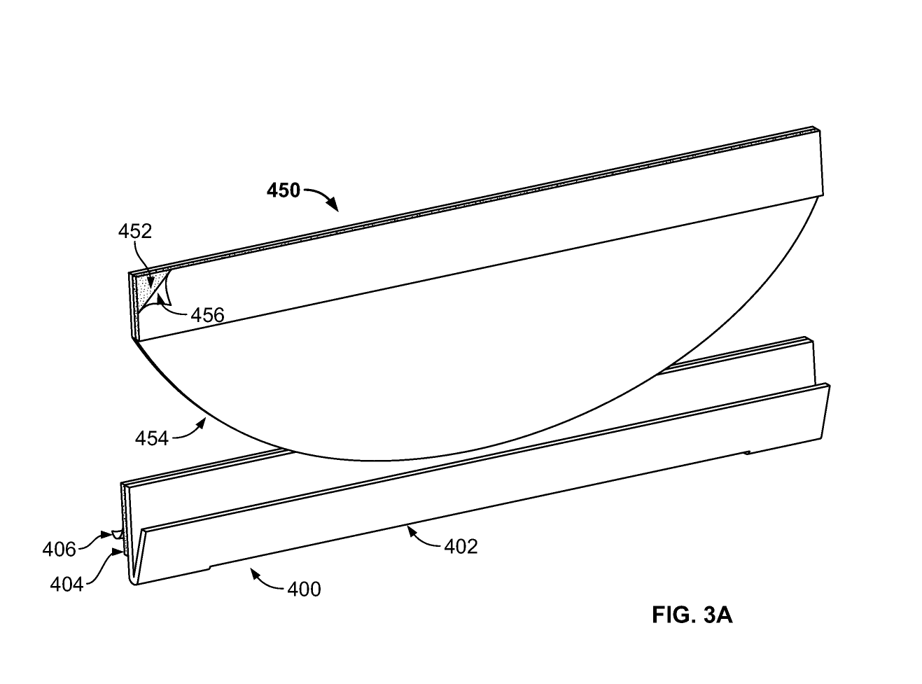

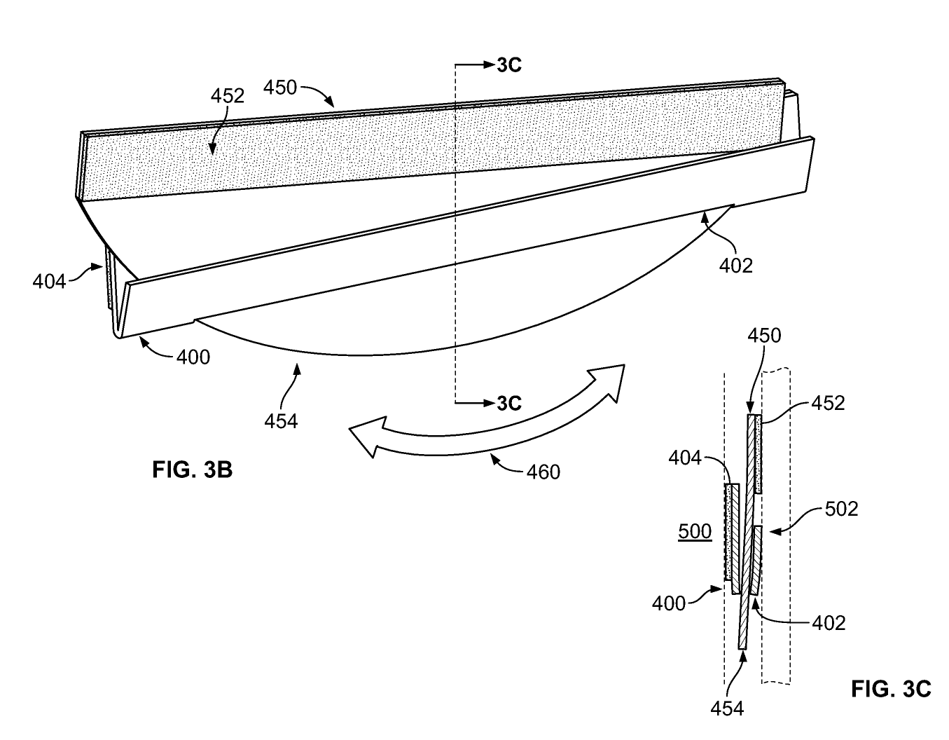

Turning to FIGS. 3A through 3C, these Figures illustrate yet another embodiment of the wall hanging and/or mounting system of the present invention. In the embodiment of FIGS. 3A through 3C, a wall hanging and/or mounting system according to the present invention is disclosed that enables a user to level the object to be hung regardless of whether or not wall portion 400 is mounted in a level manner on the wall onto which an object is to be hung and/or mounted or whether an objection portion 450 is mounted in a level manner on the object.

Turning to this embodiment, the wall hanging and/or mounting system of the present invention is composed of a folded wall portion 400 that contains a slot 402 and an adhesive strip 404. As can be seen in FIG. 3A, adhesive strip 404 can be located on the back side of one portion of folded wall portion 400, while slot 402 is located at the bottom of the fold of folded wall portion 400. Optionally, adhesive strip 404 can include any suitable release strip, or liner, 406 that serves to protect adhesive strip 404 prior to adhesive strip 404 being attached to a wall. In one instance, folded wall portion 400 is V-shaped with slot 402 being located at the point of the V. Additionally, as is also illustrated in FIG. 3A, the wall hanging and/or mounting system of the present invention further comprises an object portion 450 that itself comprises an adhesive strip 452 located at the top of object portion 450 and a curved edge 454 located at the bottom of object portion 450. Curved edge 454 of object portion 450 is designed to operatively engage slot 402 of wall portion 400. Additionally, the curved nature of curved edge 454 permits a user to tilt object portion 450 to either the left or the right relative to wall portion 400 thereby permitting a user to achieve a level mounting of the object to which object portion 450 is attached regardless of whether or not wall portion 400 was mounted to a wall in a horizontally level orientation and/or regardless of whether or not object portion 450 was mounted to the object to be hung in a horizontally level orientation (see arrow 460 of FIG. 3B for one non-limiting example). It should be noted that the length and width of slot 402 is not critical so long as a sufficient amount of curved edge 454 is able to pass through slot 402, thereby permitting the operative engagement of wall portion 400 with object portion 450. In use, adhesive strip 404 is used to secure wall portion 400 to a place on a wall where the object is desired to be placed, while adhesive strip 452 is used to secure object portion 450 to the object to be hung or mounted.

As would be understood by those of skill in the art, depending upon the weight of the object to be hung and/or mounted on a wall the amount of adhesive present on either one, or both, of portions 400 and 450 can be increased. Alternatively, a different type of adhesive material could be utilized where the holding strength of the adhesive materials of adhesive strips 404 and/or 452 is/are increased in response to the amount of weight that is desired to be secured by the overall wall hanging and/or mounting system of the present invention.

In one embodiment, adhesive strip 404 is formed from any suitable adhesive material and can be selected from a double-sided adhesive tape that has a permanent adhesive material on one side (the side that is secured to the wall portion 400 of the wall hanging system of the present invention), a removable adhesive material on the other side (the side that is used to secure the wall portion 400 of the present invention to a wall surface) and a foam core. In one embodiment, adhesive strip 452 is formed from any suitable adhesive material and can be selected from a double-sided adhesive tape that has a permanent adhesive material on one side (the side that is secured to the object portion 450 of the wall hanging system of the present invention), a removable adhesive material on the other side (the side that is used to secure the object portion 450 of the present invention to the object to be hung on a wall) and a foam core there between. Again, such double-sided tapes are known to those of skill in the art and are available from Essentra Specialty Tapes of Forest Park, Ill., USA.

In another embodiment, adhesive strip 404 is formed from a double-sided tape material having an adhesive material that is selected so as to have a removable and reusable adhesive on both sides of the tape. Such double-sided tapes with removable adhesives on both sides are known to those of skill in the art, and as such a detailed discussion herein is omitted for the sake of brevity. In still another embodiment, at least the portion of adhesive strip 404 that contacts the wall surface is formed from an adhesive material that is selected so as to be removable, reusable and residue-free. Again, such adhesive materials are known to those of skill in the art and as such a detailed discussion herein is omitted for the sake of brevity. As used herein “residue-free” means that no undesirable stains or other residues are left on the wall surface onto which adhesive strip 404 is placed. In another embodiment, adhesive strip 452 is formed from a double-sided tape material having an adhesive material that is selected so as to have a removable and reusable adhesive on both sides of the tape. Such double-sided tapes with removable adhesives on both sides are known to those of skill in the art, and as such a detailed discussion herein is omitted for the sake of brevity. In still another embodiment, at least the portion of adhesive strip 452 that contacts the wall surface is formed from an adhesive material that is selected so as to be removable, reusable and residue-free. Again, such adhesive materials are known to those of skill in the art and as such a detailed discussion herein is omitted for the sake of brevity. As used herein “residue-free” means that no undesirable stains or other residues are left on the wall surface onto which adhesive strip 452 is placed.

The thickness of adhesive strip 404 is not critical. Additionally, the thickness of adhesive strip 452 is not critical so long as adhesive strip 452 is of sufficient thickness to create a functional gap between the object and the lower part of object portion 450 so as to permit the curved edge 454 of object portion 450 to be able to pass through slot 402 of wall portion 400 when engagement of wall portion 400 and object portion 450 are desired. In one embodiment, adhesive strip 452 is independently formed so as to have a thickness of about 0.02 inches to about 0.25 inches, or from about 0.05 inches to about 0.15 inches, or from about 0.06 inches to about 0.1 inches, or even about 0.0625 inches. Here, as well as elsewhere in the specification and claims, individual numerical values can be combined to form additional and/or non-disclosed ranges.

Turning to FIG. 3C, this Figure illustrate how wall portion 400 and object portion 450 operatively engage one another when each portion, portions 400 and 450, are secured to a wall surface 500 and an object 502 (e.g., a picture frame) to be hung or mounted. As would be apparent to those of skill in the art and as can be seen from FIGS. 3B and 3C, if wall portion 400 is mounted in a level horizontal orientation it may not be necessary to tilt object portion 450 from left to right in order to achieve the desired level mounting or hanging of the object to be placed on a wall surface. Alternatively, as is illustrated in FIGS. 3B and 3C, if wall portion 400 is mounted in such a manner that it is not horizontally level, object portion 450 can be tilted one way, or the other, so as to overcome the non-level mounting of wall portion 400 thereby still achieving a desired level mounting, or hanging, of an object on a wall surface (see arrow 460 of FIG. 3B). Further, if object portion 450 is mounted in such a manner that it is not horizontally level, object portion 450 can be tilted one way, or the other, so as to overcome the non-level mounting of object portion 450 thereby still achieving a desired level mounting, or hanging, of an object on a wall surface.

As would be apparent to those of skill in the art, any of the adhesive portions or strips of the various embodiments of the present invention can further include a release strip, or liner, so as to protect the adhesive portions or strips of the various embodiments of the present invention when the adhesive is not in use. The nature of such a release strip, or liner, is well known to those of skill in the art. As such, any suitable release strip, or liner, material known in the labeling, tape, or mounting device arts can be utilized.

As noted above, the wall portion of the present invention and the object portion can be identical or different. Given this, a number of non-limiting examples of overall wall hanging systems in accordance with the present invention will now be described in detail. In one embodiment, the wall hanging system of the present invention comprises: a wall portion (100 and/or 200), the wall portion comprising a body having a first side and a second side and an adhesive strip, wherein the adhesive strip is located on the first side of the body of the wall portion and is formed so as to cover only a lower portion of the first side of the body of the wall portion; and an object portion (100 and/or 200), the object portion comprising a body having a first side and a second side and an adhesive strip, wherein the adhesive strip is located on the first side of the body of the object portion and is formed so as to cover only an upper portion of the first side of the body of the object portion, wherein the adhesive strip of the wall portion operatively engages a wall surface and the adhesive strip of the object portion operatively engages an object to be hung, or mounted, on the wall, and wherein the lack of an adhesive strip on an upper portion of the first side of the wall portion creates a space between the body of the wall portion and the wall that the lower portion of the body of the object portion is able to securely engage. In another embodiment, one, or both, of the wall portion and/or object portion further comprises an adhesive guard located on the first side of the wall portion's body and/or located on the first side of the object portion's body. In still another embodiment, one, or both, of the wall portion and/or object portion further comprises a bottom lip formed from a raised horizontal, or slanted, ridge located on the first side of the wall portion's body and/or located on the first side of the object portion's body. In still another embodiment, one, or both, of the wall portion and/or object portion further comprises one or more raised locking features located on the first side of the wall portion's body and/or located on the first side of the object portion's body.

In another embodiment, the wall hanging system of the present invention comprises: a wall portion (100 and/or 200), the wall portion comprising a body having a first side and a second side, an adhesive strip and an adhesive guard, wherein the adhesive strip is located on the first side of the body of the wall portion and is formed so as to cover only a lower portion of the first side of the body of the wall portion and the adhesive guard is formed from a raised horizontally oriented ridge located above a top edge of the adhesive strip; and an object portion (100 and/or 200), the object portion comprising a body having a first side and a second side, an adhesive strip and an adhesive guard, wherein the adhesive strip is located on the first side of the body of the object portion and is formed so as to cover only an upper portion of the first side of the body of the object portion and the adhesive guard is formed from a raised horizontally oriented ridge located below a bottom edge of the adhesive strip, wherein the adhesive strip of the wall portion operatively engages a wall surface and the adhesive strip of the object portion operatively engages an object to be hung, or mounted, on the wall, and wherein the lack of an adhesive strip on an upper portion of the first side of the wall portion creates a space between the body of the wall portion and the wall that the lower portion of the body of the object portion is able to securely engage. In another embodiment, one, or both, of the wall portion and/or object portion further comprises a bottom lip formed from a raised horizontal, or slanted, ridge located on the first side of the wall portion's body and/or located on the first side of the object portion's body. In still another embodiment, one, or both, of the wall portion and/or object portion further comprises one or more raised locking features located on the first side of the wall portion's body and/or located on the first side of the object portion's body.

A wall hanging system comprising: a folded wall portion 400, the folded wall portion comprising a body having a first portion and a second portion that are joined together along an edge, an adhesive strip and a slot, wherein the adhesive strip is located on the back side of the second portion of the body and the slot is formed in a portion of the edge that joins the first portion and the second portion of the body; and an object portion 450, the object portion comprising a body having a first side and a second side, an adhesive strip, and a curved bottom edge, wherein the adhesive strip is located on the second side of the body of the object portion and is formed so as to cover only an upper portion of the second side of the body of the object portion, wherein the adhesive strip of the wall portion operatively engages a wall surface and the adhesive strip of the object portion operatively engages an object to be hung, or mounted, on the wall, and wherein the curved edge of the body of the object portion is formed so as to pass through the slot formed in the body of the wall portion.

In still another embodiment, the positions of wall portion 400 and object portion can be reversed such that portion 400 becomes the object portion and portion 450 becomes the wall portion. In this embodiment, the present invention relates to a wall hanging system comprising: a folded object portion 400 that serves as the object portion of the wall hanging system and a wall portion 450 having a curved edge. As would be apparent to those of skill in the art, this embodiment differs from the embodiment of FIGS. 3A through 3C in that when the wall portion of the system of the present invention is formed from the curved portion 450 the mounting of this portion to a wall surface is done so that the curved edge is facing upwards. Additionally, the mounting of the folded portion 400 that serves as the object portion in this embodiment is done so that the slot 402 is located along the top edge of the object portion 400. Given that all that changes is the orientation of portions 400 and 450 in this embodiment an additional set of Figures is omitted for the sake of brevity.

While in accordance with the patent statutes the best mode and certain embodiments of the invention have been set forth, the scope of the invention is not limited thereto, but rather by the scope of the attached. As such, other variants within the spirit and scope of this invention are possible and will present themselves to those skilled in the art.

1. A wall hanging system comprising:
a wall portion, the wall portion comprising a body having a first side and a second side and an adhesive strip, wherein the adhesive strip is located on the first side of the body of the wall portion and is formed so as to cover only a lower portion of the first side of the body of the wall portion; and
an object portion, the object portion comprising a body having a first side and a second side and an adhesive strip, wherein the adhesive strip is located on the first side of the body of the object portion and is formed so as to cover only an upper portion of the first side of the body of the object portion,
wherein the adhesive strip of the wall portion operatively engages a wall surface and the adhesive strip of the object portion operatively engages an object to be hung, or mounted, on the wall, and
wherein the lack of an adhesive strip on an upper portion of the first side of the wall portion creates a space between the body of the wall portion and the wall that the lower portion of the body of the object portion is able to securely engage.

2. The wall hanging system of claim 1, wherein the each of the bodies of the wall portion and the object portion are independently formed from metal, plastic or wood.

3. The wall hanging system of claim 1, wherein each of the bodies of the wall portion and the object portion are independently formed from a plastic, or polymer, material selected from a polypropylene polymer, a polystyrene polymer, a polyethylene polymer, or an acrylonitrile butadiene styrene polymer.

4. The wall hanging system of claim 1, wherein the adhesive strip of the wall portion and the adhesive strip of the object portion are each formed from a double-sided adhesive tape having a foam core.

5. The wall hanging system of claim 4, wherein the double-sided adhesive tape has a permanent adhesive on one side and a removable adhesive on the opposite side.

6. The wall hanging system of claim 4, wherein the double-sided adhesive tape has a removable adhesive on both sides of the double-sided tape.

7. The wall hanging system of claim 1, wherein the wall portion further comprises an adhesive guard located on the first side of the wall portion's body.

8. The wall hanging system of claim 1, wherein the object portion further comprises an adhesive guard located on the first side of the object portion's body.

9. The wall hanging system of claim 1, wherein the wall portion further comprises a bottom lip formed from a raised horizontal, or slanted, ridge located on the first side of the wall portion's body.

10. The wall hanging system of claim 1, wherein the object portion further comprises a bottom lip formed from a raised horizontal, or slanted, ridge located on the first side of the object portion's body.

11. The wall hanging system of claim 1, wherein the wall portion further comprises one or more raised locking features located on the first side of the wall portion's body.

12. The wall hanging system of claim 1, wherein the object portion further comprises one or more raised locking features located on the first side of the object portion's body.

13. A wall hanging system comprising:
a wall portion, the wall portion comprising a body having a first side and a second side, an adhesive strip and an adhesive guard, wherein the adhesive strip is located on the first side of the body of the wall portion and is formed so as to cover only a lower portion of the first side of the body of the wall portion and the adhesive guard is formed from a raised horizontally oriented ridge located above a top edge of the adhesive strip; and
an object portion, the object portion comprising a body having a first side and a second side, an adhesive strip and an adhesive guard, wherein the adhesive strip is located on the first side of the body of the object portion and is formed so as to cover only an upper portion of the first side of the body of the object portion and the adhesive guard is formed from a raised horizontally oriented ridge located below a bottom edge of the adhesive strip,
wherein the adhesive strip of the wall portion operatively engages a wall surface and the adhesive strip of the object portion operatively engages an object to be hung, or mounted, on the wall, and
wherein the lack of an adhesive strip on an upper portion of the first side of the wall portion creates a space between the body of the wall portion and the wall that the lower portion of the body of the object portion is able to securely engage.

14. The wall hanging system of claim 13, wherein the each of the bodies of the wall portion and the object portion are independently formed from metal, plastic or wood.

15. The wall hanging system of clam 13, wherein each of the bodies of the wall portion and the object portion are independently formed from a plastic, or polymer, material selected from a polypropylene polymer, a polystyrene polymer, a polyethylene polymer, or an acrylonitrile butadiene styrene polymer.

16. The wall hanging system of claim 13, wherein the adhesive strip of the wall portion and the adhesive strip of the object portion are each formed from a double-sided adhesive tape.

17. The wall hanging system of claim 16, wherein the double-sided adhesive tape has a permanent adhesive on one side and a removable adhesive on the opposite side and a foam core there between.

18. The wall hanging system of claim 16, wherein the double-sided adhesive tape has a removable adhesive on both sides of the double-sided tape and a foam core there between.

19. The wall hanging system of claim 13, wherein the wall portion further comprises a bottom lip formed from a raised horizontal, or slanted, ridge located on the first side of the wall portion's body.

20. The wall hanging system of claim 13, wherein the object portion further comprises a bottom lip formed from a raised horizontal, or slanted, ridge located on the first side of the object portion's body.

21. The wall hanging system of claim 13, wherein the wall portion further comprises one or more raised locking features located on the first side of the wall portion's body.

22. The wall hanging system of claim 13, wherein the object portion further comprises one or more raised locking features located on the first side of the object portion's body.

23.-36. (canceled)

37. The wall hanging system of claim 1, wherein the adhesive strip of the wall portion is of sufficient thickness to create a gap between the wall and the adhesive-free top portion of the first surface of the wall portion.

38. The wall hanging system of claim 37, wherein the adhesive portion of the wall portion is formed to have a thickness of about 0.02 inches to about 0.25 inches.

39. The wall hanging system of claim 37, wherein the adhesive portion of the wall portion is formed to have a thickness of about 0.05 inches to about 0.15 inches.

40. The wall hanging system of claim 37, wherein the adhesive portion of the wall portion is formed to have a thickness of about 0.06 inches to about 0.1 inches.

41. The wall hanging system of claim 37, wherein the adhesive portion of the wall portion is formed to have a thickness of about 0.0625 inches.

42. The wall hanging system of claim 1, wherein the adhesive strip of the wall portion operatively engages a wall surface without fasteners or an anchoring device.

43. The wall hanging system of claim 1, wherein at least one of the wall portion and the object portion are made from a material having a flexural modulus between approximately 1.1 GPa to 3.0 GPa.

44. The wall hanging system of claim 1, wherein the object portion has a shape that is identical to a shape of the wall portion.

45. A wall hanging system comprising:
a wall portion, the wall portion comprising a body having a first side and a second side and an adhesive strip, wherein the adhesive strip is located on the first side of the body of the wall portion and is formed so as to cover only a lower portion of the first side of the body of the wall portion; and
an object portion, the object portion comprising a body having a first side and a second side and an adhesive strip, wherein the adhesive strip is located on the first side of the body of the object portion and is formed so as to cover only an upper portion of the first side of the body of the object portion,
wherein the adhesive strip of the wall portion operatively engages a wall surface without fasteners or an anchoring device and the adhesive strip of the object portion operatively engages an object to be hung, or mounted, on the wall, and
wherein the lack of an adhesive strip on an upper portion of the first side of the wall portion creates a space between the body of the wall portion and the wall that the lower portion of the body of the object portion is able to securely engage.

46. The wall hanging system of claim 45, wherein the adhesive strip of the wall portion and the adhesive strip of the object portion are each formed from a double-sided adhesive tape having a foam core.

47. The wall hanging system of claim 46, wherein the double-sided adhesive tape has a permanent adhesive on one side and a removable adhesive on the opposite side.

48. A wall hanging system comprising:
a wall portion, the wall portion comprising a body having a first side and a second side and an adhesive strip, wherein the adhesive strip is located on the first side of the body of the wall portion and is formed so as to cover only a lower portion of the first side of the body of the wall portion; and
an object portion, the object portion comprising a body having a first side and a second side and an adhesive strip, wherein the adhesive strip is located on the first side of the body of the object portion and is formed so as to cover only an upper portion of the first side of the body of the object portion,
wherein the adhesive strip of the wall portion operatively engages a wall surface without fasteners or an anchoring device and the adhesive strip of the object portion operatively engages an object to be hung, or mounted, on the wall, and
wherein the lack of an adhesive strip on an upper portion of the first side of the wall portion creates a space between the body of the wall portion and the wall that the lower portion of the body of the object portion is able to securely engage.
wherein the adhesive strip of the wall portion may be removed from the wall without damaging the wall.

49. The wall hanging system of claim 48, wherein at least one of the wall portion and the object portion are made from a material having a flexural modulus between approximately 1.1 GPa to 3.0 GPa.

50. The wall hanging system of claim 48, wherein the object portion has a shape that is identical to a shape of the wall portion.
